(19) United States
(12) Patent Application Publication
(10) Pub. No.: US 2009/0031402 A1
(43) Pub. Date: Jan. 29, 2009

(54) METHOD AND APPARATUS FOR MANAGING ACCESS PRIVILEGE IN CLDC OSGI ENVIRONMENT

(75) Inventors: Dong-shin JUNG, Suwon-si (KR); Subramanian KRISHNAMOORTHY, Bangalore (IN); Lohith VRUSHABENDRAPPA, Bangalore (IN); Vanraj VALA, Bangalore (IN); Vinoth SASIDHARAN, Bangalore (IN)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/178,254

(22) Filed: Jul. 23, 2008

(30) Foreign Application Priority Data
Jul. 23, 2007 (IN) 1586/CHE/2007
Mar. 21, 2008 (KR) 10-2008-0026295

(51) Int. Cl. G06F 21/00

(52) U.S. Cl. 726/4

(57) ABSTRACT

Provided are a method and apparatus for managing an access privilege of an application in a Connected Limited Device Configuration (CLDC) and Open Service Gateway initiative (OSGi) environment. The method includes: marking a privileged code in the application; executing the privileged code in a secured thread having a unique thread identifier; identifying the privilege code by mapping the unique thread identifier with an application identifier from a mapping table; checking a permission policy file to determine what kind of resource access privilege the identified privileged code has; and permitting the application to access the resources according to the determination results. Accordingly, when an application tries to access resources in a framework, an access privilege of the application can be managed so that no applications can maliciously access the resources by identifying the application by using the mapping table and checking the security policy file of the identified application.

### CROSS-REFERENCE TO RELATED PATENT APPLICATION

This application claims priority from Indian Patent Application No. 1586/CHE/2007, filed on Jul. 23, 2007, in the Indian Intellectual Property Office and Korean Patent Application No. 10-2008-0026295, filed on Mar. 21, 2008, in the Korean Intellectual Property Office, the disclosures of which are incorporated herein by reference.

### BACKGROUND OF THE INVENTION

1. Field of the Invention

The present invention relates to a framework for dynamically installing an application, and more particularly, to a method and apparatus for managing an access privilege of an application to resources in a Connected Limited Device Configuration (CLDC) Open Service Gateway initiative (OSGi) environment.

2. Description of the Related Art

Most terminal devices and embedded devices used today include a Java Programming language platform in order to execute java applications that are inbuilt or downloaded in the platform. One such platform is Java 2 Micro Edition (J2ME). J2ME architecture is particularly targeted to embedded systems with limited resources, such as mobile phones, pagers, Personal Digital Assistants (PDAs), smart cards and set-top boxes.

However, since there are big differences between these devices in terms of function and performance, the J2ME architecture was designed in a pattern in which its configuration and profile are separated from each other in order for the J2ME platform to be used in multiple applications. Together, the configuration and profile define a minimum set of Application Programming Interfaces (APIs) that a device must support. An advantage of this concept is that any application that is produced by using any one of the defined APIs can run on the J2ME platform. In general, this set can be extended together with additional optional libraries if necessary, e.g., in a case where a user wants to add an API to a program.

Two representative configurations related to J2ME are Connected Limited Device Configuration (CLDC) and Connected Device Configuration (CDC). Platforms formed with Mobile Information Device Profile (MIDP) and CLDC are targeted to Central Processing Units (CPUs) having relatively limited performance than CDC or memory-limited systems, and standard Java platforms adopt APIs and application Virtual Machine (VM) technologies.

### SUMMARY OF THE INVENTION

The present invention provides a method and apparatus for managing an access privilege of an application which can overcome the limitation that only one application may run on one Virtual Machine (VM) at a time in an execution environment of driving applications using VMs, and prevent applications from maliciously accessing resources in a framework.

According to an aspect of the present invention, there is provided a method of managing an access privilege of an application to resources in an execution environment where applications are driven by using a Virtual Machine (VM), the method comprising: marking a privileged code in the application; executing the privileged code in a secured thread having a unique thread identifier; identifying the privileged code by mapping the unique thread identifier with an application identifier from a mapping table; checking a permission policy file to determine what kind of resource access privilege the privileged code has; and permitting the application to access the resources according to the determination results.

According to another aspect of the present invention, there is provided a computer-readable recording medium having a program recorded thereon, the program if executed by a computer causes the computer to execute the method.

According to another aspect of the present invention, there is provided an apparatus for managing an access privilege of an application to resources in an execution environment where applications are driven by using a VM, a thread providing unit which provides a secured thread having a unique thread identifier to execute a privileged code marked in the application; an identifying unit which identifies the privileged code by mapping the unique thread identifier with an application identifier from a mapping table; and a checking unit which checks a permission policy file to determine what kind of resource access privilege the identified privileged code has and permitting the application to access the resources according to the determination results.

### BRIEF DESCRIPTION OF THE DRAWINGS

The above and other aspects of the present invention will become more apparent by describing in detail exemplary embodiments thereof with reference to the attached drawings in which:

FIG. 1A is a block diagram of a Connected Limited Device Configuration (CLDC) Mobile Information Device Profile (MIDP) platform;

FIG. 1B is a block diagram of a CLDC Open Service Gateway initiative (OSGi) framework;

FIG. 2 is a block diagram of a system for managing an access privilege of an application to resources in a CLDC OSGi environment;

FIG. 3A is a block diagram of a security architecture of an CLDC OSGi framework according to an exemplary embodiment of the present invention;

FIG. 3B illustrates an application and a privileged code in the application in the security architecture of FIG. 3A;

FIG. 4 is a block diagram of an apparatus for managing an access privilege of an application to resources in a framework, according to an exemplary embodiment of the present invention; and

FIG. 5 is a flowchart illustrating a method of managing an access privilege of an application to resources in a framework, according to an exemplary embodiment of the present invention.

### DETAILED DESCRIPTION OF EXEMPLARY EMBODIMENTS OF THE INVENTION

Exemplary embodiments of the present invention will now be described more fully with reference to the accompanying drawings.

In the exemplary embodiments described below, a framework refers to an execution environment where applications are driven by using a Virtual Machine (VM).

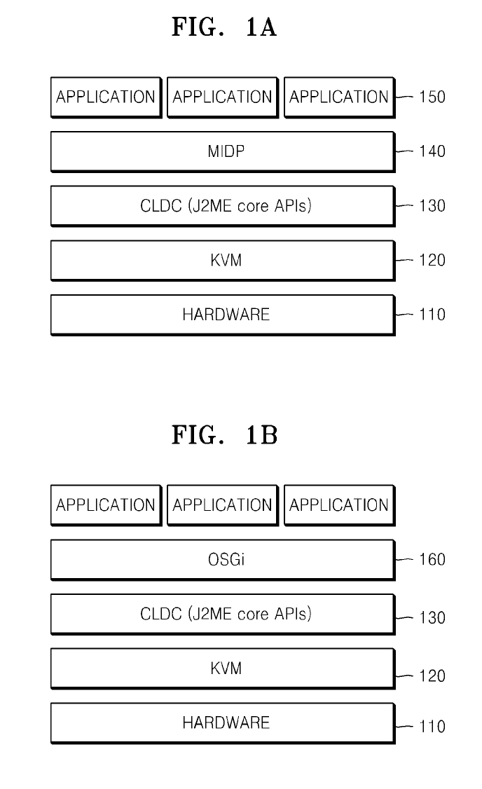

FIG. 1A is a block diagram of a Connected Limited Device Configuration (CLDC) Mobile Information Device Profile (MIDP) platform. Referring to FIG. 1A, the CLDC MIDP platform includes hardware 110, a KVM 120, a CLDC 130, an MIDP 140, and applications 150. The KVM 120 is software for executing an application independently from a platform on the hardware 110. The VM in a CLDC-MIDP environment may be a K virtual machine (KVM) 120. The KVM is a platform-independent VM for driving the CLDC 130, which includes core Application Programming Interfaces (APIs) of Java 2 Micro Edition (J2ME), and the MIDP 140.

FIG. 1A illustrates CLDC-MIDP as the pair of configuration and profile described above. The CLDC 130 defines a VM and a set of libraries, which are scaled down compared to those specified in the Java Language Specification. The CLDC 130 is tailored to embedded devices having limited resources, for example, mid-to-low performance mobile phones. The MIDP 140 defines a simple model for application programming, which includes an application model, a user interface, (e.g., a textbox or form), and networking. In this environment, the plurality of applications 150 are loaded and executed on top of the CLDC-MIDP platform.

However, the CLDC-MIDP platform does not have robust resources to spare and is found to lag behind the standard Java platform in terms of APIs and application VM technologies. Also, in Java frameworks in the related art, only one Java application can be executed on one VM at a time. Accordingly, in order to execute a plurality of applications in the related art, a plurality of VMs are inefficiently driven on hardware.

A proposed solution to the above-mentioned problems of the MIDP-CLDC platform is as Open Service Gateway initiative (OSGi) including an application framework having higher performance than the MIDP-CLDC platform, which will be explained with reference to FIG. 1B.

FIG. 1B is a block diagram of a CLDC-OSGi framework. The CLDC-OSGi framework of FIG. 1B has a similar structure to that of FIG. 1A, but adopts an OSGi 160. The OSGi 160 is a middleware framework that is independently operated from an operating system or a service platform, and is a system environment in which applications can be dynamically installed and deleted by using Java. Technically, the OSGi 160 is a generic, service centric, execution environment that specifies a generic framework and a core set of service interfaces that enable delivery of multiple value added service implementations, potentially from different vendors.

In other words, the OSGi 160 provides a general-purpose, secure, and managed Java framework that supports the deployment of extensible and downloadable service applications known as bundles from different vendors. The OSGi 160 provides service by installing a jar file-type physical bundle including a Java class file. The bundle forms a fundamental unit of service deployment and management. Accordingly, OSGi-compliant devices can download and install OSGi bundles, and remove them when they are no longer required in the OSGi-compliant devices. Bundles, in turn, can register a plurality of services that can be shared with other bundles under the control of the OSGi 160. Since the OSGi 160 has a service registry, the OSGi 160 performs service registration, search, execution, and removal.

The OSGi 160 can be executed on top of the CLDC 130 or a Foundation Profile (FP). Furthermore, in the OSGi 160, a plurality of bundles can be executed simultaneously on a single VM. In other words, there is no need to load and execute the VM as many times as the number of running Java applications. Once a VM is loaded, a plurality of bundles can be executed on the VM simultaneously, thereby significantly reducing memory consumption. Thanks to the robustness of the OSGi 160, the Java Specification Request (JSR) has proposed using OSGi as an underlying application framework for mobile devices.

However, the OSGi 160 implemented on the CLDC 130 has significant drawbacks regarding the security of applications. The drawbacks are basically attributed to the CLDC 130 offering limited support for the complete Java 2 Security on which the entire OSGi security design depends. There is no mention of any mechanism or method to manage access privileges to a code in an application executed in a CLDC-OSGi environment.

The exemplary embodiments of the present invention described below overcome these drawbacks by providing a method of preventing applications executed in a CLDC OSGi environment from maliciously accessing other service or applications of OSGi.

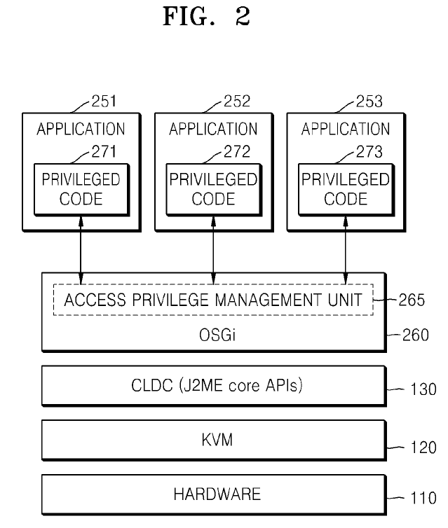

FIG. 2 is a block diagram of a system for managing an access privilege of an application to resources in a CLDC OSGi environment. The system of FIG. 2 has a similar structure to that of FIG. 1B except that an OSGi 260 further includes an access privilege management unit 265 managing access requests of applications 251, 252, and 253.

For example, if applications 251, 252, and 253 do not have appropriate authentication or security means to access and use a specific service in the OSGi 260 or other applications, the framework may be exposed to a malicious resource access request from the outside. Accordingly, the various exemplary embodiments of the present invention suggest the inclusion of an access privilege managing unit 265 which manages such resource access requests and permits access for only authorized requests. In particular, applications 251, 252, and 253 may have privileged codes 271, 272, and 273, respectively, and may acquire access privileges to specific resources by using the privileged codes 271, 272, and 273.

Although a framework in the exemplary embodiments below is described by assuming a CLDC OSGi environment, it could be easily understood by one of ordinary skill in the art that various execution environments other than the CLDC OSGi environment may be used in the present invention.

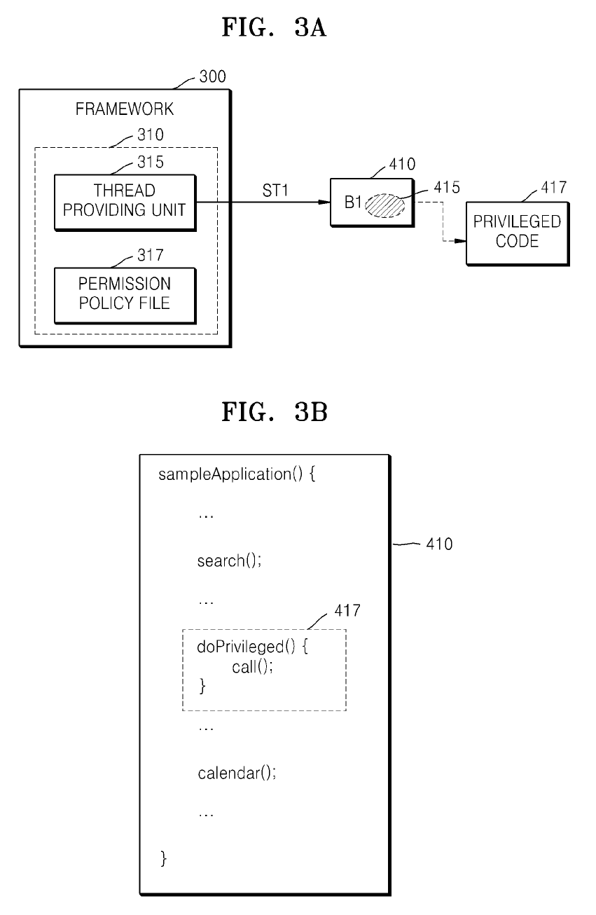

FIG. 3A is a block diagram of a security architecture of a CLDC OSGi framework according to an exemplary embodiment of the present invention. Referring to FIG. 3A, the security architecture according to the current exemplary embodiment of the present invention includes a framework 300 and an application B1 410 that is a bundle installed in the framework 300.

The framework 300 includes a privilege managing unit 310 managing a resource access privilege of the application 410. The privilege managing unit 310 includes a thread providing unit 315 and a permission policy file 317.

The thread providing unit 315 manages a secured thread ST1 provided to execute the newly installed application 410. The application B1 410 is executed on the provided secured thread ST1. The secured thread ST1 is provided for every application, and may be a custom thread designed to meet the characteristics of the framework 300. A secured thread ST1 corresponding to one application B1 410 is shown in FIG. 3A.

When an application accesses specific resources, e.g., other applications or service of the framework 300, the application must have an access privilege. A privileged code 417 refers to one of a plurality of codes in the application to which an access privilege is granted. An access privilege refers to specific resources of the framework 300. That is, when the privilege managing unit 310 of the framework 300 permits a command or service request marked in the privileged code 417 in the application B1 410, resources corresponding to the request may be accessed. For example, since the application B1 410 has a set of access privileges 415, the application B1 410 is permitted to access corresponding resources. If the application B1 410 fails to acquire the set of access privileges 415, the application B1 410 is not permitted to access the corresponding resources.

The permission policy file 317 manages a policy to determine what kind of resources each application may access and use. The permission policy file 317 may be recorded on a specific file or a DataBase (DB).

FIG. 3B illustrates the application B1 410 and the privileged code 417 in the application B1 410 of the security architecture of FIG. 3A. The application B1 410 and the privileged code 417 of FIG. 3A are illustrated as program codes in FIG. 3B. It is assumed that the application B1 410 of FIG. 3B is a software program installed in a mobile phone, and has functions of searching a telephone book, making calls, and managing a calendar.

sampleApplication( ) corresponds to the application B1 410 and includes the three functions that are expressed as functions search( ), call( ), and calendar( ). It is assumed that the function of managing the calendar can be used with a common privilege in the use of resources of the mobile phone because the function of managing the calendar does not cause a special security problem unlike the function of searching the telephone book. However, it is assumed that the function of making the calls accompanying phone charges requires a specific privilege in the use of the resources of the mobile phone. In this case, the function call( ) corresponding to the function of making the calls cannot be used unless the specific privilege is acquired from a framework that corresponds to a software implementation environment of the mobile phone. That is, without permission, the resources of the framework cannot be used.

In FIG. 3B, the function call( ) may be specified as a privileged code 417 by using a mark doPrivileged( ). The function call( ) corresponding to the privileged code 417 among the three functions search( ), call( ), and calendars in the application sampleApplication( ) is executed when there is an access request for the resources of the framework and the access request is permitted. Accordingly, the privileged code 417 may be designed to have access permission to all the resources of the framework. Of course, whether to permit the privileged code 417 is determined by the privilege managing unit 310 (see FIG. 3A) of the framework.

A method of assigning a secured thread to each of a plurality of applications installed in a framework in order to execute the application has been explained. Such secured threads accept examination of resource access privileges according to a permission policy included in the framework.

A security architecture driving model for examining a privilege of a secured thread that tries to access resources of a framework will now be explained.

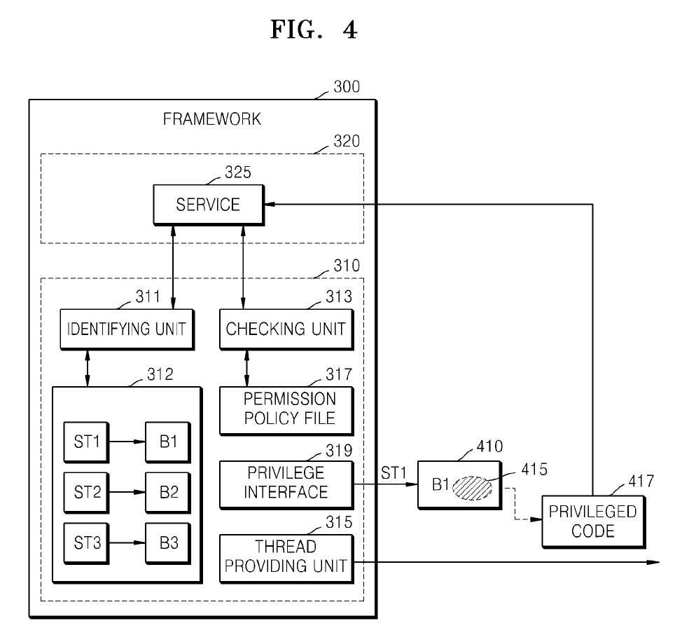

FIG. 4 is a block diagram of an apparatus for managing an access privilege of an application to resources in a framework 300, according to an exemplary embodiment of the present invention. Referring to FIG. 4, the apparatus according to the current exemplary embodiment includes a service registry 320 in addition to the privilege managing unit 310 of FIGS. 3A and 3B. The privilege managing unit 310 includes an identifying unit 311, a mapping table 312, a checking unit 313, a thread providing unit 315, a permission policy file 317, and a privilege interface 319. Each element will now be explained.

The service registry 320 is a managing unit for registering, searching, executing, and removing services provided by the framework 300. FIG. 4 illustrates that one service 325 is registered.

The thread providing unit 315 provides a secured thread ST1 to execute the privileged code 417 marked in the application B1 410 as described above. The secured thread ST1 has a unique thread identifier different from that of any other thread.

The privileged code 417 may be marked by the privilege interface 319, and satisfies a series of standards for communications with the application B1 410 in the design of the framework 300. For example, when an application including a security function of marking a privileged code in the application is developed by developers according to the development guide for applications installable in the framework 300, the privilege managing unit 310 of the framework 300 can detect the privileged code 417 by using the privilege interface 319. Since the application B1 410 acquires permissions by using the privilege interface 319 and the privileged code 417 in this way, the application B1 410 is permitted to access some specific resources of the framework 300.

The thread providing unit 315 not only provides the secured thread ST1 but also terminates the provided secured thread ST1 if necessary. That is, after execution of the privileged code 417 is completed, the thread providing unit 315 may terminate mapping between the secured thread ST1 and the application along with the unique identifier. Since the thread providing unit 315 may terminate the secured thread ST1, the framework 300 can ensure that other applications cannot maliciously reuse the secured thread ST1 for executing the privileged code 417.

The mapping table 312 stores a thread identifier and a corresponding application identifier as one pair. It may be determined from the mapping table 312 which secured thread is assigned to a certain application. FIG. 4 illustrates the mapping table 312 showing that the secured thread ST1 corresponds to the application B1 410. The mapping table 312 may ensure that no applications other than the application B1 410 assigned to the secured thread ST1 may use the secured thread ST1 for executing the privileged code 417.

The identifying unit 311 identifies an application, or a privileged code in the application, by mapping a unique thread identifier with an application identifier from the mapping table 312. For example, when the application B1 410 requests to access the service 325, the identifying unit 311 checks the mapping table 312 by using the thread identifier of the secured thread ST1 carrying the request. As a result of the check, it can be identified that an application corresponding to the secured thread ST1 is the application B1 410.

The checking unit 313 checks the permission policy file 317 to determine what kind of resource access privilege the identified application has. As a result of the checking, the checking unit 313 permits the identified application to access resources when the identified application has a resource access privilege, and rejects the identified application to access the resources when the identified application has no resource access privilege. For example, the application B1 410 inquires about the permission policy file 317 through the checking unit 313. If the application B1 410 has an access privilege to the service 325 as a result of the inquiry, then the set of access privileges 415 are granted to the application B1 410. Accordingly, the application B1 410 is permitted to access the service 325.

An apparatus for managing an access privilege of an application to resources in a framework, according to an exemplary embodiment of the present invention, has been explained with reference to FIG. 4. Since the application is identified by using the mapping table 312 and the permission policy file 317 of the privileged code in the identified application is checked, the access privilege of the application can be managed so that applications cannot maliciously access the resources in the framework 300. Also, when the framework 300 is implemented in a CLDC OSGi environment, a plurality of applications may be executed on one VM, thereby significantly reducing memory consumption.

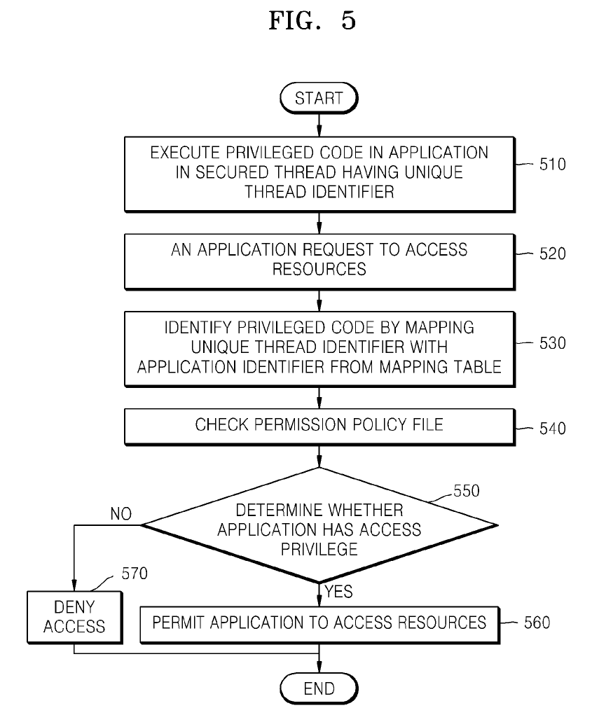

FIG. 5 is a flowchart illustrating a method of managing an access privilege of an application to resources of a framework, according to an exemplary embodiment of the present invention.

Referring to FIG. 5, in operation 510, a privileged code in an application in a secured thread having a unique thread identifier is executed. For example, when an OSGi application is installed in a CLDC OSGi environment, the OSGi application and a privileged code in the OSGi application may be executed in a security custom thread provided by a thread providing unit. The security custom thread has a unique thread identifier different from that of any other thread.

In operation 520, the executed application requests an access to resources. Here, the resources refer to services or other applications in a framework.

In operation 530, the privileged code in the application is identified by mapping the unique thread identifier with an application identifier from a mapping table.

In operation 540, a permission policy file is checked to determine what kind of access privilege the application has. In the privilege managing unit 310, the checking unit 313 determines an access privilege of the application by comparing the access request with the permission policy file 317 existing in the CLDC OSGi framework. (See FIG. 4). The access privilege may be preset, and is dependent on factors such as location and signer. For example, if it was previously agreed that the framework grants all resource access privileges to applications of a company A, then the request may be accepted when an application whose signer is the company A who requests to access resources.

In operation 550, it is determined whether the application has an access privilege to resources. If it is determined in operation 550 that the application has an access privilege to the resources, the method proceeds to operation 560. In operation 560, the application is permitted to access the resources. If it is determined in operation 550 that the application does not have access privilege to the resources, the method proceeds to operation 570. In operation 570, the application is denied from accessing the resources. When the application is denied from accessing the resources, an exception, which is an error processing method of a Java framework, may be executed. When execution of the privileged code is completed, mapping between the secured thread and the application may be terminated along with the unique identifier. Hence, the framework can ensure that applications may not maliciously reuse the secured thread for executing the privileged code.

The method of managing an access privilege of an application to resources in a framework, according to an exemplary embodiment of the present invention, has been explained with reference to FIG. 5. The privileged code in the application may be managed so that applications may not maliciously access the resources in the framework. Also, when the framework is implemented in a CLDC OSGi environment, a plurality of applications may be executed on one VM, thereby reducing memory consumption.

The present invention may be embodied as computer-readable codes on a computer-readable recording medium. The computer-readable recording medium is any data storage device that can store data which can be thereafter read by a computer system.

Examples of the computer-readable recording medium include read-only memories (ROMs), random-access memories (RAMs), CD-ROMs, magnetic tapes, floppy disks, and optical data storage devices. The computer-readable recording medium can also be distributed over network coupled computer systems so that the compute readable code is stored and executed in a distributed fashion. Functional programs, codes, and code segments for embodying the present invention may be easily deducted by programmers in the art which the present invention belongs to.

The invention can also be embodied as computer readable codes on a computer readable transmission medium. Examples of the computer readable transmission medium include carrier waves (such as data transmission through the Internet).

As described above, when an application tries to access resources in a framework, an access privilege of the application can be managed so that no applications maliciously access the resources by identifying the application by using the mapping table and checking the security policy file of the identified application. Also, when the framework is in a CLDC OSGi environment, since a plurality of applications can be executed on one VM, memory consumption can be reduced significantly.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of managing an access privilege of an application to resources in an execution environment where applications are driven by using a Virtual Machine (VM), the method comprising:
marking a privileged code in the application;
executing the privileged code in a secured thread comprising a unique thread identifier;
identifying the privileged code by comparing the unique thread identifier to a corresponding application identifier from a mapping table;
checking a permission policy file to determine resource access privileges the privileged code has; and
permitting the application to access the resources according to the resource access privileges.

2. The method of claim 1, further comprising executing an exception if the application does not have access privilege to the resources.

3. The method of claim 1, further comprising terminating the secured thread after the executing of the privileged code.

4. The method of claim 1, wherein the permitting of the application to access the resources comprises assigning a set of permissions to the secured thread.

5. The method of claim 1, wherein the privileged code is detected by a privilege interface.

6. The method of claim 1, wherein the mapping table stores a plurality of application identifiers of a plurality of applications in the execution environment corresponding with a plurality of unique thread identifiers of threads in which the plurality of applications are executed.

7. The method of claim 1, wherein the execution environment is a Connected Limited Device Configuration (CLDC) Open Service Gateway initiative (OSGi) environment.

8. A computer-readable recording medium having a program recorded thereon, the program if executed by a computer causes the computer to execute the method of claim 1.

9. An apparatus for managing an access privilege of an application to resources in an execution environment where applications are driven by using a Virtual Machine (VM), the apparatus comprising:
a thread providing unit which provides a secured thread comprising a unique thread identifier to execute a privileged code marked in the application;
an identifying unit which identifies the privileged code by comparing the unique thread identifier to a corresponding application identifier from a mapping table; and
a checking unit which checks a permission policy file to determine resource access privileges of the identified privileged code and permits the application to access the resources according to the resource access privileges.

10. The apparatus of claim 9, further comprising an exception executing unit which executes an exception if the application has no access privilege to the resources.

11. The apparatus of claim 9, wherein the thread providing unit terminates the secured thread after execution of the privileged code.

12. The apparatus of claim 9, wherein the checking unit assigns a set of permissions to the secured thread so that the application can access the resources.

13. The apparatus of claim 9, wherein the privileged code is detected by a privilege interface.

14. The apparatus of claim 9, wherein the mapping table stores a plurality of application identifiers of a plurality of applications in the execution environment with a plurality of corresponding unique thread identifiers of threads in which the plurality of applications are executed.

15. The apparatus of claim 9, wherein the execution environment is a Connected Limited Device Configuration (CLDC) Open Service Gateway initiative (OSGi) environment.
